(19) United States
(12) Patent Application Publication
(10) Pub. No.: US 2010/0051133 A1
(43) Pub. Date: Mar. 4, 2010

(54) METHOD OF REFILLING A CONTAINER AND AN AUXILIARY DEVICE FOR REFILLING A CONTAINER FROM A RESERVOIR

(75) Inventors: Bartele Hendrik De Vries, Drachten (NL); Reinier Niels Lap, Surhuizum (NL); Olaf Martin De Jong, Drachten (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS N.V., EINDHOVEN (NL)

(21) Appl. No.: 12/515,971

(22) PCT Filed: Nov. 27, 2007
(86) PCT No.: PCT/IB07/54808

§ 371 Date: May 22, 2009

(30) Foreign Application Priority Data
Nov. 30, 2006 (EP) 06125086.6

(51) Int. Cl. B65B 1/04; B67D 7/84

(52) U.S. Cl. 141/1; 222/173; 141/369

(57) ABSTRACT

The invention relates to a method of refilling a container (4) for a domestic appliance apparatus (3) from a fluid-containing reservoir (2). The reservoir (2) includes a movable actuator (7) for activating pressure means for dispensing the fluid. According to the method the reservoir (2) is put in communication with the container (4) and the actuator (7) is activated by an auxiliary device (1) to transfer a quantity of fluid to the container (4). The auxiliary device (1) comprises a housing (6) which accommodates a holder (9) for holding the reservoir (2) and an actuator driver (8) for activating the actuator (7). The auxiliary device (1) may be part of a refilling assembly, which also comprises a reservoir (2) and/or a refillable container (4).

### FIELD OF THE INVENTION

The invention relates to a method of refilling a container.

### BACKGROUND OF THE INVENTION

Certain personal care devices such as some types of shavers are provided with a container which is filled with a fluid, for example lotion or soap, so as to provide the possibility to supply the fluid to a part of the device where it is desired. When the container is empty the user may replace it by a filled container. It is however desired that the user can refill the container by himself, for example by connecting it to a fluid-containing reservoir and transfer a quantity of fluid from the reservoir to the container. It appears that some people have the experience that this is a rather difficult operation.

### SUMMARY OF THE INVENTION

It would be advantageous to provide a simple method of refilling a container for a domestic appliance apparatus.

This is achieved by the method according to claim 1. The advantage of these features is that a reservoir having a movable actuator for dispensing the fluid can be used such that a quantity of fluid can be transferred to the container without the necessity of applying a manual force upon the actuator of the reservoir but using a powered auxiliary device. The powered auxiliary device delivers work for activating the actuator and may function by way of electrical, pneumatical, hydraulical or magnetical energy. The domestic appliance apparatus may be a shaver, a tooth brush or the like. The fluid may be a lotion, a gel or emulsion, such as a shaving lotion, shaving emulsion, tooth paste, mouth washing lotion or the like.

In practice, this means for example, that people who already use this type of reservoir can still use this, but then without the need for manual operation when refilling the container. Particularly, this is a benefit to elderly and disabled persons for whom manually refilling appears to be rather strenuous.

The advantage of the method according to claim 2 is that the powered auxiliary device can be used for both activating the actuator and guiding the fluid from the reservoir to the container, so that the powered auxiliary device is efficiently applied.

Claim 3 defines a practical method of refilling since a known type of reservoir has a pump including an actuator to be activated by a reciprocating motion.

The advantage of the method according to claim 4 is that this method guarantees that the actuator is in its neutral position when the reservoir is replaced. This facilitates replacement of the container without already dispensing fluid when installing a filled reservoir on the powered auxiliary device due to applying a force on the actuator.

The invention also relates to an auxiliary device according to claim 5. The auxiliary device is suitable to apply the method such as described above and is therefore advantageous. A further advantage is that the auxiliary device is also capable of dispensing a quantity of fluid to another receiver than a container for a domestic appliance apparatus. The powered driving means may function by way of electrical, pneumatical, hydraulical or magnetical energy, or alternatively on the basis of a venturi effect.

The advantage of the feature of claim 6 is that a transmission provides the opportunity to adjust the speed and direction of the motion of the actuator driver with respect to that of the driving means.

The advantage of the features of claim 7 is that the actuator driver is integrated with a fluid transfer conduit, hence resulting in a compact auxiliary device.

The advantage of the features of claim 8 is that the auxiliary device is suitable for receiving certain known reservoirs having an actuator requiring a reciprocating motion, for example for activating a pump in the reservoir.

The features of claim 9 are beneficial as an eccentrical mechanism is an effective and reliable mechanism to create a reciprocating motion.

The advantage of the features of claim 10 is that a cam-shaped wheel is a simple and low-cost eccentrical mechanism.

The auxiliary device according to claim 11 has the advantage that the actuator driver has a reciprocating motion with respect to the axis of rotation of the lever whereas the amplitude of the lever near the axis of rotation is very low. This means that the motion of the outlet with respect to the housing is small or even negligible which facilitates a connection to the refillable container or avoids dispensed fluid to be flung out in different directions after exiting the outlet. The advantage of the releasable mounting of the actuator driver and the outlet to the lever is that it facilitates cleaning of these components.

An auxiliary device according to claim 12 is typically suitable to refill a container separately or as a part of an apparatus, having an inlet connector which is compatible to the outlet connector of the auxiliary device. The apparatus containing the refillable container may be a domestic appliance or personal care appliance apparatus, such as a shaver or a tooth brush. In the case of a tooth brush the fluid may be tooth paste or gel. If the second holder is adapted to receive an apparatus it may also be adapted to recharge a battery of the apparatus when the apparatus is connected to the second holder. In this case the housing may accommodate a battery charging system, as well.

The auxiliary device such as defined in claim 13 prevents the reservoir from being moved with respect to the holder when the actuator driver activates the actuator of the reservoir. After fitting the reservoir to the holder of the auxiliary device the reservoir can be clamped to the holder by the clamping means. As a consequence, the reservoir has a fixed position with respect to the holder and the housing. This avoids the motion of the reservoir together with the motion of the actuator driver when the auxiliary device is operated.

The advantage of the features such as defined in claim 14 is that the device is prevented from being overloaded, for example in the case of a stuck actuator of the reservoir. In that case, when the force of the actuator driver on the actuator exceeds the back force of the resilient element, the entire reservoir is moved with respect to the housing of the auxiliary device.

Preferred embodiments of the auxiliary device are defined in claims 6-14.

The invention also relates to a refilling assembly. This may have different embodiments such as defined in one of the claims 15-17.

It is noted that an automatic dispensing system for soap is well-known, for example from the U.S. Pat. No. 6,036,056. This device includes an electric motor, a motor reducing gear set and an eccentric wheel which pushes against a squeezer set which squeezes a soap hose to dispense liquid soap. The soap hose communicates with a reservoir which is filled with liquid soap. However, the known dispensing device is not arranged for a reservoir having a movable actuator for dispensing the soap.

The above-mentioned aspects and other aspects of the invention will be apparent from the following description with reference to the drawings.

The invention also includes any possible combination of features or subject matter as claimed in any one of the claims.

### BRIEF DESCRIPTION OF THE DRAWINGS

FIG. 1 is a perspective view of an embodiment of a refilling assembly, provided with a shaver.

FIG. 2 is a similar view as FIG. 1, but the assembly is provided with a refillable container only.

FIG. 3 is a schematic view of an embodiment of the auxiliary device and a reservoir, illustrating the operation principle.

### DETAILED DESCRIPTION OF EMBODIMENTS

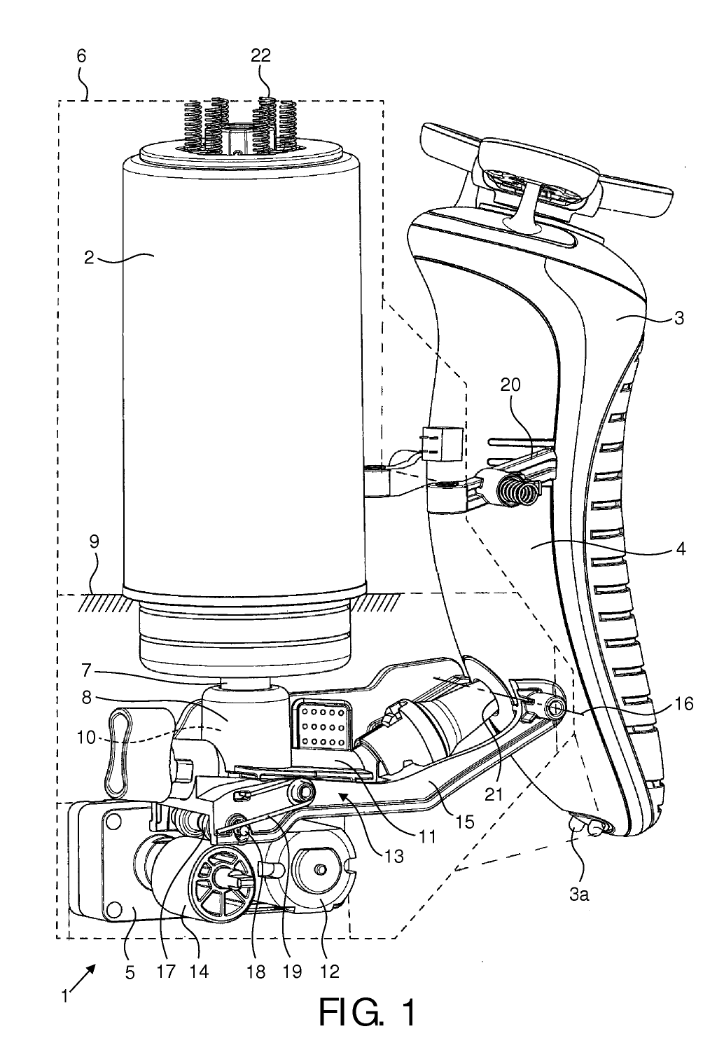

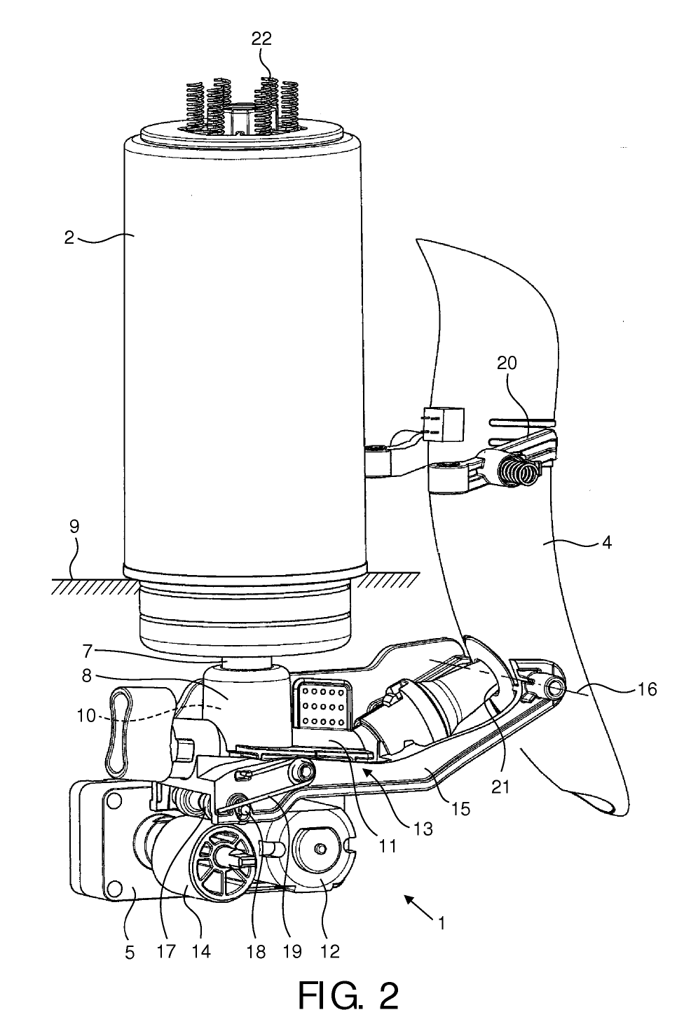

FIG. 1 shows an embodiment of a refilling assembly comprising a powered auxiliary device 1, a fluid-containing reservoir 2 and a shaver 3. In FIG. 2 the shaver 3 is replaced by a refillable container 4 only. The embodiment of the auxiliary device 1 such as shown in FIGS. 1 and 2 is used to refill a container 4 attached to or integrated in a shaver 3, or to refill a separate container 4, respectively. Of course, the auxiliary device 1 can also be used for refilling a container 4 for other types of domestic appliance apparatus.

In general, certain types of domestic appliance apparatus for personal care are provided with a refillable container which is filled with a fluid, for example lotion or soap, so as to provide the possibility to supply the fluid to a part of the device where it is desired. In the case of a shaver 3 shaving cream is desired near razor blades of the shaver 3 so as to improve the shaving quality. When the container 4 is empty the user may replace it by a filled container 4. In the case of FIG. 1, however, the shaver 3 including the container 4 can be refilled automatically. In the case of FIG. 2 the container 4 separated from the shaver 3 can be refilled automatically.

The auxiliary device 1 comprises a housing 6 (virtually shown by a broken line in FIG. 1). The housing 6 accommodates a holder 9 for holding the reservoir 2. The holder 9 has a fixed position with respect to the housing 6. The auxiliary device 1 is also provided with a second holder 20, which is shown in FIGS. 1 and 2. In the shown embodiment the second holder 20 projects from the housing 6. The second holder 20 is arranged for holding the refillable container 4 or an apparatus 3 including a refillable container 4. The apparatus may be a domestic appliance or personal care appliance apparatus, such as a shaver (shown in FIG. 1) or a tooth brush.

The second holder 20 can also be a combined one, which is suitable for refilling a container 4 as well as recharging a battery of the shaver 3 in the case that the shaver 3 is provided with a battery. In that case the housing 6 may also accommodate a battery charger and be provided with an electrical connector (not shown) which mates with an electrical connector 3a of the shaver 3, such as shown in FIG. 1.

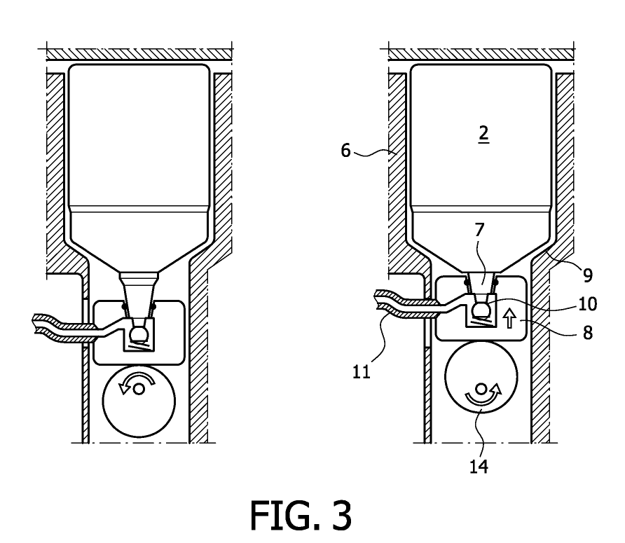

The reservoir 2 includes a movable actuator 7 for activating pressure means to dispense a quantity of fluid out of the reservoir 2, see also FIG. 3. In the embodiments of FIGS. 1, 2 and that of FIG. 3 the pressure means are formed by a pump in the reservoir 2 which functions by a reciprocating motion of the actuator 7 substantially parallel to the longitudinal axis of the reservoir 2. A reservoir 2 having its own pump is known and commercially available. However, for some people, such as elderly and disabled persons it is too strenuous to operate the pump manually.

The auxiliary device 1 according to the invention is provided with an actuator driver 8 for activating the actuator 7 of the reservoir 2 when this is connected to a holder 9, which holder 9 is fixed to the housing 6. The actuator driver 8 comprises a fluid receiving chamber 10, such as shown in FIG. 3 (this cannot be seen in FIGS. 1 and 2). This means that the actuator driver 8 has at least two functions: 1) activating the actuator 7 of the reservoir 2 and 2) receiving and transferring the dispensed fluid through a conduit 11 in the direction of an outlet of the auxiliary device 1. FIG. 3 shows that the receiving chamber 10 communicates with the outlet of the reservoir 2 and the conduit 11. Thus, the actuator driver 8 forms an interface between the reservoir 2 and the conduit 11. The actuator driver 8 and the conduit 11 may be releasably mounted to the auxiliary device 1 so as to enable cleaning thereof.

The embodiment of the auxiliary device 1 such as shown in FIGS. 1 and 2 further comprises an electric motor 12 as a powered driving means for driving the actuator driver 8 via a transmission 13. In order to create a reciprocating motion of the actuator driver 8 the transmission 13 is provided with a cam-shaped wheel 14 as an eccentrical mechanism, which eccentrical wheel 14 is driven by the electric motor 12 via a gearbox 5. The gearbox 5 is fixed to the housing 6. The transmission 13 further comprises a lever 15 which is rotatable around an axis of rotation 16 and mounted to the housing 6 at a distance from the axis of rotation of the cam-shaped wheel 14 as seen in a direction perpendicular to the direction of the reciprocating motion. Note, that in the embodiment of FIG. 3 the cam-shaped wheel 14 directly contacts the actuator driver 8.

The pumping speed can be adjusted by varying the rotation speed of the cam-shaped wheel 14. The dispensed quantity per pumping stroke is defined by the rate of eccentricity of the cam-shaped wheel 14. Furthermore, the cam may have a special profile so as to obtain an optimal acceleration of the actuator driver 8.

The cam-shaped wheel 14 contacts the lever 15 via rollers 17. The rollers 17 are connected to an axle 18, which is movably connected to the lever 15 via a spring 19. This is a common way of mechanically connecting the cam-shaped wheel 14 to the actuator driver 8. The spring 19 has the effect of eliminating play in the mechanism between the actuator 7 of the reservoir 2 and the cam-shaped wheel 14. Play might have been caused by production tolerances of the dimensions of the reservoir 2.

The distance between the axis of rotation 16 and the actuator driver 8 is such that the actuator driver 8 approaches a linear movement.

The outlet of the auxiliary device 1 ends up in a connector 21 which is adapted to mate with a counterpart of the container 4 or apparatus 3 so as to enable transfer of fluid from the reservoir 2 to the refillable container 4 or apparatus 3. The conduit 11 is releasably connected to the lever 15 which means that the conduit 11 moves together with the lever 15 when the device 1 is in operation. The connector 21 is located near the axis of rotation 16, which means that during operation of the auxiliary device 1 the amplitude of the connector 21 is small. When the refillable container 4 or apparatus 3 is connected to the second holder 20. The small amplitude of the connector 21 prevents the container 4 or apparatus 3 from vibrating on the second holder 20.

The housing 6 is further provided with a clamping mechanism for removably fixing the reservoir 2 to the holder 9. The clamping mechanism may clamp the reservoir 2 to the holder 9 after placing the reservoir 2 on the holder 9. This results in a fixed position of the reservoir 2 with respect to the housing 6. The clamping mechanism avoids the motion of the reservoir 2 together with the motion of the actuator driver 8 when the auxiliary device 1 is operated. In the embodiment shown in FIGS. 1 and 2 the clamping mechanism comprises a resilient element in the form of coil springs 22. This prevents the auxiliary device 1 from being overloaded in the case when the actuator 7 is stuck, for example. The spring force of the coil springs 22 is preferably higher than the pumping force, such that under normal conditions the actuator driver 8 is moved with respect to the reservoir 2.

A commercially available reservoir 2 may have an outlet port which directly fits into an inlet port of the container 4 so as to enable the user to fill the container 4 manually. As the auxiliary device 1 has the function of an intermediate component it is very useful when the actuator driver 8 has the same connector features as the inlet port of the container 4.

The embodiment of the auxiliary device 1 such as shown in FIGS. 1 and 2 is very suitable to apply the method of refilling a container 4 according to the present invention. The reservoir 2 can be put in communication with the container 4 whereas the auxiliary device 1 can activate the actuator 7 of the reservoir 2. Due to the presence of the receiving chamber 10 within the actuator driver 8 the reservoir 2 can be put in communication with the container 4 through the auxiliary device 1.

The actuator driver 8 can be activated between a neutral position and a maximal stroke. The neutral position is shown in the left picture of FIG. 3 and a nearly maximal stroke is shown in the right picture of FIG. 3. In the neutral position the force applied on the actuator 7 is negligible. It is advantageous to move the actuator driver 8 to the neutral position after a refilling operation, because of easier replacement of the reservoir 2 when necessary. It facilitates the replacement of the reservoir 2 without already dispensing fluid when installing a filled reservoir 2 to the auxiliary device 1.

From the foregoing it will be clear that the invention provides a method of refilling a container, an auxiliary device and a refilling assembly. According to the invention refilling of a container for a domestic appliance apparatus is very simple.

The invention is not restricted to the above-described embodiments as shown in the drawings, which can be varied in several ways without departing from the scope of the claims. It is for example not necessary that the actuator driver 8 and the receiving chamber 10 are integrated. It is for example, possible that the actuator 7 of the reservoir 2 is located at a different position with respect to the dispensing outlet of the reservoir 2. Furthermore, it is possible that the auxiliary device is not only used for refilling a container for a domestic appliance apparatus, but also for dispensing fluid in the hands of a user. In that case a simple device is provided for people who cannot operate a commercially available reservoir 2 as described above, but wish to use the reservoir 2 and the auxiliary device 1 as an automated fluid dispensing unit.

In general it is noted that, in this application, the expression “comprising” does not exclude other elements or steps, and “a” or “an” does not exclude a plurality. Reference signs in the claims shall not be construed as limiting the scope thereof.

1. A method of refilling a container (4) for a domestic appliance apparatus (3) from a fluid-containing reservoir (2), which reservoir (2) includes a movable actuator (7) for dispensing the fluid, by putting the reservoir (2) in communication with the container (4) and activating the actuator (7) by a powered auxiliary device (1) to transfer a quantity of fluid to the container (4).

2. A method of refilling according to claim 1, wherein the reservoir (2) is put in communication with the container (4) through the auxiliary device (1).

3. A method of refilling according to claim 1, wherein the reservoir (2) comprises a pump which is activated via the actuator (7) by a reciprocating motion.

4. A method of refilling according to claim 1, wherein the actuator (7) is activated between a neutral position and a maximal stroke, in which neutral position a negligible force is applied on the actuator (7), wherein the actuator (7) is moved to the neutral position after a refilling operation.

5. An auxiliary device (1) comprising a housing (6) which accommodates
a holder (9) for holding a fluid-containing reservoir (2) which reservoir (2) includes a movable actuator (7) for activating pressure means to dispense a quantity of fluid,
an actuator driver (8) for activating the actuator (7) of the reservoir (2) when this reservoir (2) is connected to the holder (9) so as to transfer the fluid to an outlet of the auxiliary device (1), and
a powered driving means (12) for driving the actuator driver (8).

6. An auxiliary device (1) according to claim 5, wherein the device comprises a transmission (13) for driving the actuator driver (8) by the driving means (12) via said transmission (13).

7. An auxiliary device (1) according to claim 6, wherein the actuator driver (8) comprises a fluid receiving chamber (10) with which an outlet of the reservoir (2) and a conduit (11) for transferring the quantity of dispensed fluid to the outlet of the auxiliary device (1) communicates.

8. An auxiliary device (1) according to claim 7, wherein the transmission (13) is adapted to create a reciprocating motion of the actuator driver (8).

9. An auxiliary device (1) according to claim 8, wherein the transmission (13) comprises an eccentrical mechanism to create the reciprocating motion.

10. An auxiliary device (1) according to claim 9, wherein the transmission (13) comprises a cam-shaped wheel (14).

11. An auxiliary device (1) according to claim 10, wherein the transmission (13) further comprises a lever (15) which is rotatable around an axis of rotation (16) and mounted to the housing (6) at a distance from an axis of rotation of the cam-shaped wheel (14) as seen in a direction perpendicular to the direction of the reciprocating motion, wherein the cam-shaped wheel (14) contacts the lever (15) and the actuator driver (8) is releasably mounted to the lever (15), and the outlet of the auxiliary device (1) is releasbly connected to the lever (15) and located near the axis of rotation (16).

12. An auxiliary device (1) according to claim 5, wherein the device (1) is provided with a second holder (20) for holding a refillable container (4) or an apparatus (3) including a refillable container (4), wherein the outlet of the auxiliary device (1) ends up in a connector (21) which is adapted to mate with a counterpart of the container (4) or apparatus (3) so as to enable transfer of fluid from the reservoir (2) to the refillable container (4) or apparatus (3).

13. An auxiliary device (1) according to claim 5, wherein the housing (6) is provided with a clamping mechanism (22) for removably fixing the reservoir (2) to the holder (9).

14. An auxiliary device (1) according to claim 13, wherein the clamping mechanism (22) comprises a resilient element.

15. A refilling assembly comprising an auxiliary device (1) according to claim 5, and a reservoir (2) containing a fluid and including a movable actuator (7) for activating pressure means to dispense a quantity of fluid.

16. A refilling assembly according to claim 15, wherein the auxiliary device (1) is provided with a second holder (20) arranged for holding a refillable container (4) or an apparatus (3) including a refillable container (4), wherein the outlet of the auxiliary device (1) ends up in a connector (21) which is releasably connectable to a counterpart of the refillable container (4) or the apparatus (3) for providing a communication between the refillable container (4) and the outlet of the auxiliary device (1).

17. A refilling assembly comprising an auxiliary device (1) according to claim 5, wherein the auxiliary device (1) is provided with a second holder (20) arranged for holding a refillable container (4) or an apparatus (3) including a refillable container (4), wherein the outlet of the auxiliary device (1) ends up in a connector (21) which is releasably connectable to a counterpart of the refillable container (4) or the apparatus (3) for providing a communication between the refillable container (4) and the outlet of the auxiliary device (1).
